(19) United States
(12) Patent Application Publication
(10) Pub. No.: US 2006/0250508 A1
(43) Pub. Date: Nov. 9, 2006

(54) METHOD FOR INSERTING A PICTURE INTO A VIDEO FRAME

(76) Inventor: Chia-Kai Chang, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/162,085

(22) Filed: Aug. 29, 2005

(30) Foreign Application Priority Data
May 9, 2005 (TW) 94114846

(51) Int. Cl. H04N 5/262

(52) U.S. Cl. 348/239

(57) ABSTRACT

A method for inserting a picture in a video frame is developed. This method inserts an emotion picture in a video frame during communication in order to raise amusement effect. Users choose an animation module through hot keys by themselves so that an emotion picture is inserted into a combination area of the video frame and combined with the video frame to form a combined frame. This combined frame is transferred to a receiving end through communication equipments and displayed on the video screen of the receiving end to improve emotion expression.

### CROSS-REFERENCE TO RELATED APPLICATION

This application claims the priority benefit of Taiwan application serial no. 9411 4846, filed on May 9, 2005. All disclosure of the Taiwan application is incorporated herein by reference.

### BACKGROUND OF THE INVENTION

1. Field of the Invention

The present invention relates to a method for processing a video frame, and particularly to method for inserting a picture into a video frame.

2. Description of Related Art

Accompanying with the development of the telecommunication technology, the communication tools of human beings in the daily life have gradually changed from corded phones to wireless cell phones. The communication media have also transferred from voices to images, and further turned into instant videos. Furthermore, in order to raise the amusement during communication, some text dialogue software provides many emotional pictures for the users to select so as to highlight emotional effect. Moreover, as the video communication has become more and more popular, providing cell phones with multiple functions including video communication has become a tendency in the near future.

There is a kind of cell phone in the market proposing the ability to deform the video images. As disclosed in Taiwan Patent Application No. 587,389, the object of which is used to set an image characteristic position according to the frames to be captured so that the mistakes of selecting the image characteristic position can be avoided.

FIGS. 1 and 2 are respectively flow chart and device block diagram illustrating conventional method for capturing image characteristic positions. Referring to FIGS. 1 and 2, in step S110, at least one characteristic indicating position is provided and saved in a characteristic indicating module 210, wherein the characteristic indicating position is a deformation identifying position of a dynamic image; then in step S120, via a viewfinder module 220, the characteristics of the previously provided characteristic indicating position and the frames captured by a frame capture window module 230 are overlapped; and then a frame is to be captured in step S130; then in step S140, the captured frame is saved at memory module 240, wherein the saved frame can be corresponding to the characteristic indicating position, and the frames can be dynamically processed according to the saved frames and the coordinate of the provided characteristic indicating position.

However, the foregoing conventional technology can only process deformation in one characteristic indication position of a captured frame, which can provide limited entertainment. The conventional technology can only process and send the video frames in a single cell phone, which is not as flexible and efficient as using the sources of the cell phones on both sides.

### SUMMARY OF THE INVENTION

In view of the above, an object of the present invention is to provide a method for inserting a picture into a video frame. First, a picture to be inserted is selected by a control signal. Then, by referencing the video frame data, a corresponding inserted position is selected to insert in the picture. Therefore, a combined frame is obtained and outputted to a receiving end. Finally, the combined frame is displayed on a device in the receiving end so that the entertainment effect is increased.

Another object of the invention is to provide a method for inserting a picture into a video frame. First, a video frame and a packed animation module are received from a receiving end. Then, a picture is inserted into a specific position of the video frame in accordance with the data obtained from decoding the packed animation module. Finally, the combined picture is displayed on the video window for rapid data transmission.

A further object of the invention is to provide a method for inserting a picture into a video frame. First, a video frame and a set of animation module indicating codes are received in a receiving end. Then, the animation module corresponding to the animation module indicating codes are determined and used to insert a picture into a specific position of the video frame. Finally, the combined picture is displayed on the video window for rapid data transmission.

The invention provides a method for inserting a picture into a video frame, the steps of the method including: receiving a control signal from an emitting end; then capturing a video frame from a video and loading an animation module corresponding to the control signal from a database, wherein the animation module includes at least a picture and a combination position information; then determining whether the animation module needs to reference the video frame; if the animation module does, then referencing the video frame to combine the video frame and the picture of the animation module into a combined frame; if the animation module dose not, then combining the video frame and the picture of the animation module into a combined frame; finally outputting the combined frame to a receiving end.

According to the method for inserting a picture into a video frame disclosed in an embodiment of the invention, the foregoing step of referencing the video frame to combine the video frame and the picture of the animation module into a combined frame further includes: selecting a combination area from the video frame and recording a set of coordinate of the combination area; combining the video frame and the picture of the animation module, wherein the picture of the animation module is inserted in the coordinate.

According to the method for inserting a picture into a video frame disclosed in an embodiment of the invention, the foregoing step of selecting a combination area from the video frame further includes: detecting multiple skin colors from the video frame; comparing the skin colors to obtain a face area; and selecting a combination area from the face area according to the combination position information of the animation module.

According to the method for inserting a picture into a video frame disclosed in an embodiment of the invention, the foregoing receiving end further receives a combined frame and displays the received combined frame on a video window.

According to the method for inserting a picture into a video frame disclosed in an embodiment of the invention, the foregoing animation module includes at least one of the picture, the combination position information, a set of audio, and a set of control instruction.

The invention provides a method for inserting a picture into a video frame, the steps of the method including: receiving a video frame and a packed animation module from an emitting end; then decoding the packed animation module to obtain a picture and a combination position information; then determining whether the animation module needs to reference the video frame; if the animation module does, then referencing the video frame to combine the video frame and the picture of the animation module into a combined frame; if the animation module dose not, then combining the video frame and the picture of the animation module into a combined frame; finally displaying the combined frame on a video window.

According to the method for inserting a picture into a video frame disclosed in an embodiment of the invention, the movements of the foregoing emitting end including: receiving a control signal; then capturing a frame from a video and loading an animation module corresponding to the control signal from a database; then packing the animation module; and finally outputting the video frame and the packed animation module, respectively.

The invention provides a method for inserting a picture into a video frame, the steps of the method including: receiving a video frame and an animation module indicating codes from an emitting end; then loading an animation module corresponding to the animation module indicating codes from a database, wherein the animation module includes at least a picture and a combination position information; then determining whether the animation module needs to reference the video frame; if it does, then referencing the video frame to combine the video frame and the picture of the animation module into a combined frame, and if it dose not, then combining the video frame and the picture of the animation module into a combined frame; finally displaying the combined frame on a video window.

According to the method for inserting a picture into a video frame disclosed in an embodiment of the invention, the movements of the foregoing emitting end including: receiving a control signal; then capturing a frame from a video and selecting the animation module indicating codes corresponding to the control signals; finally outputting the video frame and the animation module indicating codes, respectively.

The invention inserts a specific picture into a specific position of a video frame according to the combination position information included in an animation module, then transmits a combined frame produced in the receiving end, and displays the combined frame on a video window for increasing the entertainment effect and data transmission rate.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart schematically illustrating a conventional method for capturing a frame characteristic position.

FIG. 2 is a block diagram schematically illustrating a conventional device for capturing a frame characteristic position.

FIG. 3A is a processing flow chart in the emitting end of the method for inserting a picture into a video frame according to an embodiment of the invention.

FIG. 3B is a processing flow chart in the receiving end of the method for inserting a picture into a video frame according to an embodiment of the invention.

FIG. 3C is a flow chart of the method for selecting a combination area from a video frame according to an embodiment of the invention.

FIG. 4A is a processing flow chart in the emitting end of the method for inserting a picture into a video frame according to another embodiment of the invention.

FIG. 4B is a processing flow chart in the receiving end of the method for inserting a picture into a video frame according to another embodiment of the invention.

FIG. 5A is a processing flow chart in the emitting end of the method for inserting a picture into a video frame according to a further embodiment of the invention.

FIG. 5B is a processing flow chart in the receiving end of the method for inserting a picture into a video frame according to a further embodiment of the invention.

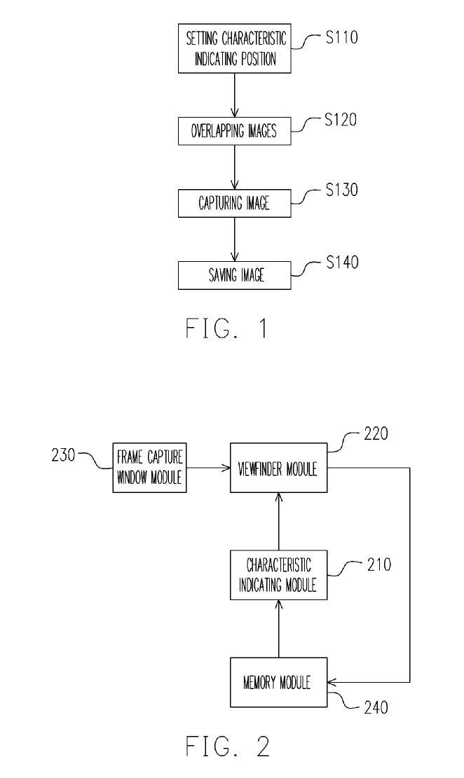

### DESCRIPTION OF THE EMBODIMENTS

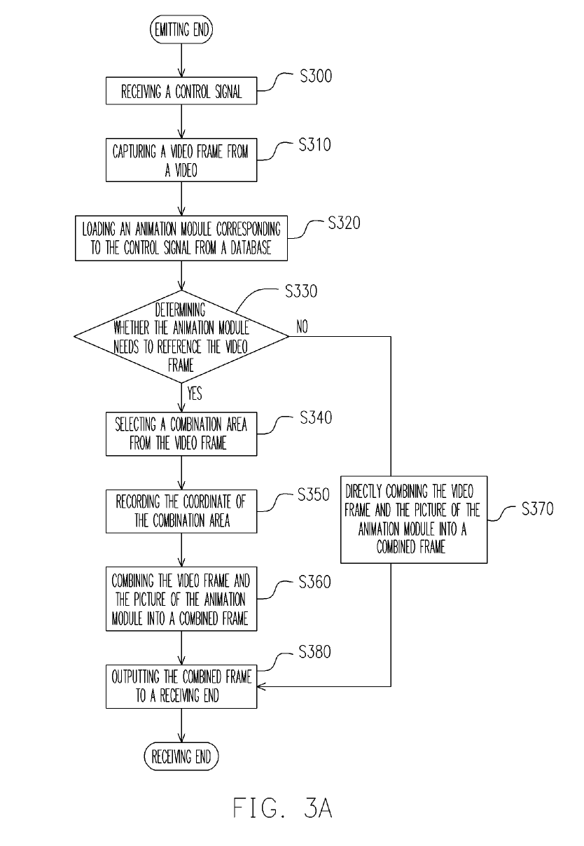

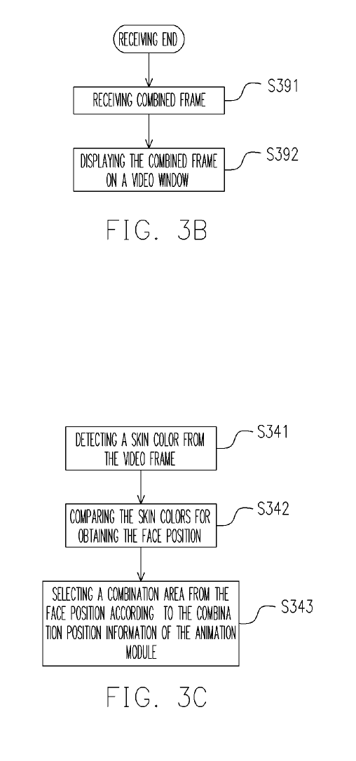

FIG. 3A is a processing flow chart in the emitting end of the method for inserting a picture into a video frame according to an embodiment of the invention. Referring to FIG. 3A, the embodiment directly combines and transmits the frames in the emitting end, wherein the combined frame can be received and displayed even under the condition that the receiving end does not support the invention. The invented method includes following steps. First, in step S300, a control signal inputted by a user is received, wherein the control signal can be a predetermined hot key signal, and the control signal can be generated via pressing the hot key in the video frame that the user would like to add an emotional picture. In step S310, a video frame is captured from a video, and then, in step S320, an animation module corresponding to the control signal is loaded from a database. In step S330, whether the animation module needs to reference the video frame is determined. If the animation module needs to reference the video frame (for example, for inserting a picture of a forehead with blue veins, the animation module needs to search for the position of the forehead), then a combination area is selected from the video frame in step S340. Then, the coordinate of the combination area is recorded in step S350. Moreover, in step S360, the video frame and the picture of the animation module are combined into a combined frame. Finally, in step S380, the combined frame is outputted to a receiving end. On the other hand, if the animation module dose not need to reference the video frame (for example, for inserting a background effect, the animation module does not need to search for a specific position), then the video frame and the picture of the animation module are directly combined into a combined frame in step S370. Similarly, in step S380, the combined frame is outputted to a receiving end. The foregoing animation module includes at least one of an image or a picture, a combination position information, a set of audio, and a set of control instruction to increase the dynamical displaying effect, but is not limited to the scope thereof. Users may use other kinds of information regarding actual needs without departing from the spirit of the present invention.

FIG. 3B is a processing flow chart in the receiving end of the method for inserting a picture into a video frame according to an embodiment of the invention. Referring to FIG. 3B, in step S391, a combined frame is received by the emitting end, and then, in step S392, the combined frame is displayed on a video window.

FIG. 3C is a flow chart of the method for selecting a combination area from a video frame according to an embodiment of the invention. The present embodiment searches for a specific face area via comparing the skin colors for inserting an emotional picture (such as a forehead with blue veins). Referring to FIG. 3C, first, in step S341, a skin color is detected from the video frame. Then, in step S342, the skin colors are compared for obtaining a face area. Finally, a combination area is selected from the face area according to the combination position information in step S343. The above-mentioned method for selecting a combination area obtains a face area only by comparing the skin colors, but is not limited to the scope thereof. Users may obtain positions of other parts of a human body or positions of any characteristic indicating objects regarding actual needs without departing from the the spirit of the present invention.

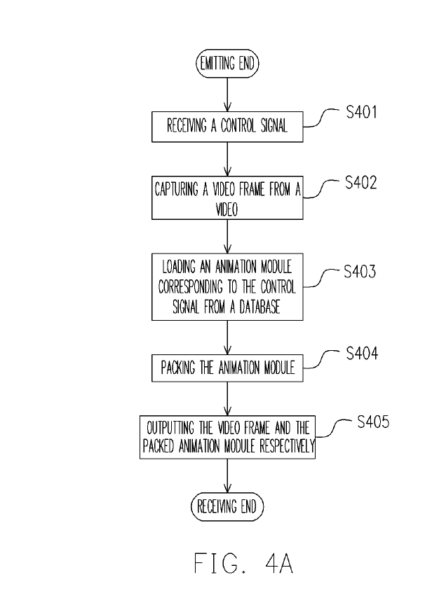

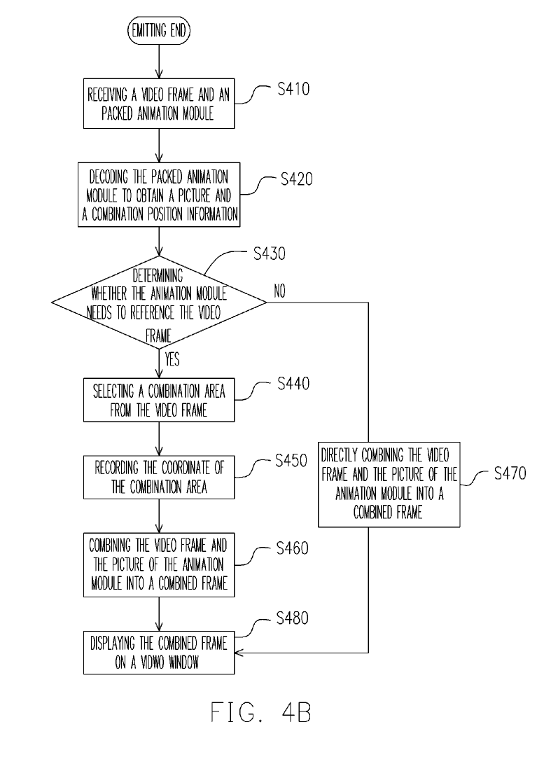

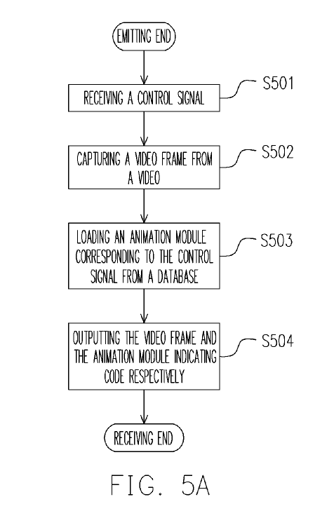

FIG. 4A is a processing flow chart in the emitting end of the method for inserting a picture into a video frame according to another embodiment of the invention. The present embodiment is suitable for the situation that both the emitting end and the receiving end support the present invention. The speed for transmitting data can be accelerated as the emitting end and the receiving end cooperate. Referring to FIG. 4A, first, a user inputted control signal is received in step S401. Then, a video frame is captured from a video in step S402. Next, an animation module corresponding to the control signal is loaded from a database in step S403. Moreover, the animation module is packed in step S404. Finally, the video frame and the packed animation module are outputted to the receiving end respectively in step S405.

FIG. 4B is a processing flow chart in the receiving end of the method for inserting a picture into a video frame according to another embodiment of the invention. Referring to FIG. 4B, first, a video frame and a packed animation module are received from an emitting end in step S410. Next, the packed animation module is decoded to obtain a picture and a combination position information in step S420. Then, in step S430, whether the animation module needs to reference the video frame is determined. If the animation module needs to reference the video frame, a combination area is selected from the video frame in step S440. Then, the coordinate of the combination area is recorded in step S450. Next, the video frame and the picture of the animation module are combined into a combined frame in step S460. Finally, the combined frame is displayed on a video window in step S480. On the other hand, if the animation module dose not need to reference the video frame, then the video frame and the picture of the animation module are directly combined into a combined frame in step S470. Similarly, in step S480, the combined frame is displayed on a video window.

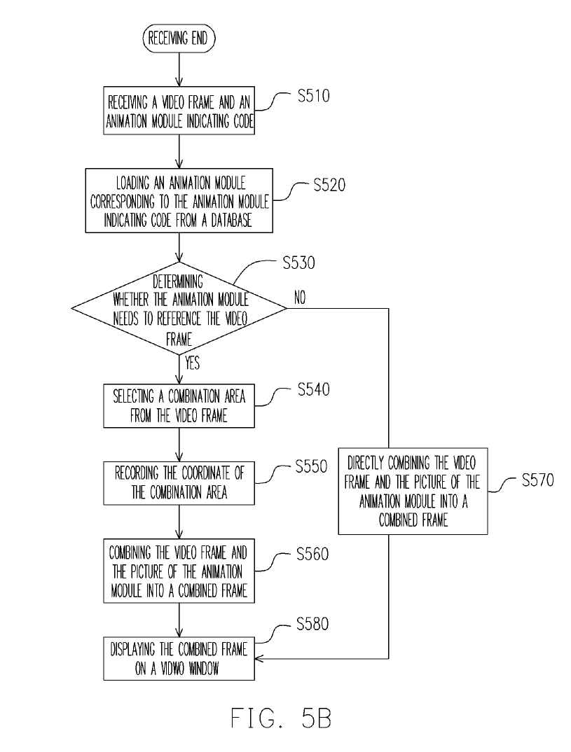

FIG. 5A is a processing flow chart in the emitting end of the method for inserting a picture into a video frame according to a further embodiment of the invention. The embodiment is suitable for the situation that both of the emitting end and the receiving end support the present invention, wherein the data to be transmitted can be greatly reduced and the transmitting speed can be increased accordingly by only emitting an animation module indicating code from the emitting end. Referring to FIG. 5A, first a user inputted control signal is received in step S501; then capturing a video frame from a video at step S502; then selecting a animation module indicating code corresponding to the control signal at step S503; and finally respectively outputting the video frame and the animation module indicating code to the receiving end at step S504.

FIG. 5B is an receiving end processing flow chart for illustrating the method for inserting a picture into a video frame according to a further embodiment of the invention. Referring to FIG. 5B, first, a video frame and a animation module indicating code are received from an emitting end in step S510. Then, a animation module corresponding to the received animation module indicating code is loaded from a database in step S520. Next, in step S530, whether the animation module needs to reference the video frame is determined. If the animation module needs to reference the video frame, then a combination area is selected from the video frame in step S540. Then, the coordinate of the combination area is recorded in step S550. Afterwards, the video frame and the picture of the animation module are combined into a combined frame in step S560. Finally, the combined frame is displayed on a video window in step S580. On the other hand, if the animation module dose not need to reference the video frame, then the video frame and the picture of the animation module are directly combined into a combined frame in step S570. Similarly, in step S580, the combined frame is displayed on a video window.

In summary, the present invention can combine a video frame and a picture into a combined frame in an emitting end, and then output the combined frame, or emit a video frame and an animation module separately from an emitting end, and then combine the video frame and the animation module in the receiving end for displaying. Wherein, the animation module is emitted after being packed so that the transmitting speed can be accelerated because of the smaller data size. In addition, the invention can also select to only emit a set of animation module indicating codes, and then read a corresponding animation module from a animation module database of the receiving end. Wherein, the animation module and the video frame are combined into a combined frame for displaying. Therefore, the present invention can not only highlight the instant communication emotion and increase the entertainment effect, but also transmit data more efficiently and rapidly.

It should be noted that specific embodiments of, and examples for, the invention are described herein for illustrative purposes, various equivalent modifications are possible within the scope of the invention, as those skilled in the relevant art will recognize that modifications and adaptations of the above-described preferred embodiments of the present invention may be made to meet particular requirements. This disclosure is intended to exemplify the invention without limiting its scope. All modifications that incorporate the invention disclosed in the preferred embodiment are to be construed as coming within the scope of the appended claims or the range of equivalents to which the claims are entitled.

What is claimed is:

1. A method for inserting a picture into a video frame, comprising:
receiving a control signal from an emitting end;
capturing a video frame from a video;
loading an animation module corresponding to the control signal from a database, wherein the animation module comprises at least a picture and a combination position information;
determining whether the animation module needs to reference the video frame;
if the animation module needs to reference the video frame, then referencing the video frame to combine the video frame and the picture of the animation module into a combined frame;
if the animation module dose not need to reference the video frame, then combining the video frame and the picture of the animation module into a combined frame; and
outputting the combined frame to a receiving end.

2. The method for inserting a picture into a video frame according to claim 1, wherein the step of referencing the video frame to combine the video frame and the picture of the animation module into a combined frame further comprises:
selecting a combination area from the video frame;
recording the coordinate of the combination area; and
combining the video frame and the picture of the animation module, wherein the picture of the animation module is inserted in the coordinate.

3. The method for inserting a picture into a video frame according to claim 2, wherein the step of selecting a combination area from the video frame further comprises:
detecting a plurality of skin colors from the video frame;
comparing the skin colors to obtain a face area; and
selecting a combination area from the face area according to the combination position information of the animation module.

4. The method for inserting a picture into a video frame according to claim 1, wherein the movements in the receiving end comprise:
receiving a combined frame; and
displaying the combined frame on a video window.

5. The method for inserting a picture into a video frame according to claim 1, wherein the control signal comprises a hot key signal.

6. The method for inserting a picture into a video frame according to claim 1, wherein the animation module comprises at least one of the picture, the combination position information, an audio, and a control instruction.

7. A method for inserting a picture into a video frame, comprising:
receiving a video frame and a packed animation module from an emitting end;
decoding the packed animation module to obtain a picture and a combination position information;
determining whether the animation module needs to reference the video frame;
if the animation module needs to reference the video frame, then referencing the video frame to combine the video frame and the picture of the animation module into a combined frame;
if the animation module dose not need to reference the video frame, then combining the video frame and the picture of the animation module into a combined frame; and
displaying the combined frame on a video window.

8. The method for inserting a picture into a video frame according to claim 7, wherein the movements in the emitting end comprise:
receiving a control signal;
capturing a video frame from a video;
loading an animation module corresponding to the control signal from a database;
packing the animation module; and
outputting the video frame and the packed animation module, respectively.

9. The method for inserting a picture into a video frame according to claim 8, wherein the control signal comprises a hot key signal.

10. The method for inserting a picture into a video frame according to claim 7, wherein the step of referencing the video frame to combine the video frame and the picture of the animation module into a combined frame further comprises:
selecting a combination area from the video frame;
recording a coordinate of the combination area; and
combining the video frame and the picture of the animation module, wherein the picture of the animation module is inserted in the coordinate.

11. The method for inserting a picture into a video frame according to claim 10, wherein the step of selecting a combination area from the video frame further comprises:
detecting a plurality of skin colors from the video frame;
comparing the skin colors to obtain a face area; and
selecting a combination area from the face area according to the combination position information of the animation module.

12. The method for inserting a picture into a video frame according to claim 7, wherein the animation module comprises at least one of the picture, the combination position information, an audio, and a control instruction.

13. A method for inserting a picture into a video frame, comprising:
receiving a video frame and an animation module indicating code from an emitting end;
loading an animation module corresponding to the animation module indicating code from a database, wherein the animation module comprise at least a picture and combination position information;
determining whether the animation module needs to reference the video frame;
if the animation module needs to reference the video frame, then referencing the video frame to combine the video frame and the picture of the animation module into a combined frame;
if the animation module dose not need to reference the video frame, then combining the video frame and the picture of the animation module into a combined frame; and
displaying the combined frame on a video window.

14. The method for inserting a picture into a video frame according to claim 13, wherein the movements in the emitting end comprise:
receiving a control signal;
capturing a video frame from a video;
selecting an animation module indicating code corresponding to the control signal; and
outputting the video frame and the animation module indicating code, respectively.

15. The method for inserting a picture into a video frame according to claim 13, wherein the step of referencing the video frame to combine the video frame and the picture of the animation module into a combined frame further comprises:
selecting a combination area from the video frame;
recording the coordinate of the combination area; and
combining the video frame and the picture of the animation module, wherein the picture of the animation module is inserted in the coordinate.

16. The method for inserting a picture into a video frame according to claim 15, wherein the step of selecting a combination area from the video frame further comprises:
detecting a plurality of skin colors from the video frame;
comparing the skin colors to obtain a face area; and
selecting a combination area from the face area according to the combination position information of the animation module.

17. The method for inserting a picture into a video frame according to claim 13, wherein the control signal comprises a hot key signal.

18. The method for inserting a picture into a video frame according to claim 13, wherein the animation module comprises at least one of the picture, the combination position information, an audio data, and a control instruction.
